(19) United States
(12) Patent Application Publication
(10) Pub. No.: US 2014/0081540 A1
(43) Pub. Date: Mar. 20, 2014

(54) METHOD OF CONTROLLING TRANSMISSION AND TRANSMISSION SYSTEM FOR PERFORMING THE SAME

(71) Applicant: HYUNDAI MOTOR COMPANY, Seoul (KR)

(72) Inventor: Byeong Wook Jeon, Seoul (KR)

(73) Assignee: Hyundai Motor Company, Seoul (KR)

(21) Appl. No.: 13/874,131

(22) Filed: Apr. 30, 2013

(30) Foreign Application Priority Data
Sep. 20, 2012 (KR) 10-2012-0104685

(51) Int. Cl. F16H 61/00

(52) U.S. Cl. CPC F16H 61/0021
USPC 701/58

(57) ABSTRACT

A method of controlling a transmission includes sensing an operation signal generated from an accelerator pedal sensor, performing a predetermined transmission in a predetermined transmission section from a current gear to a target gear, determining a change in the speed of the operation signal, controlling a constant value at which a release hydraulic pressure signal is maintained constant during the transmission in response to the change, controlling an increase slope of an engagement hydraulic pressure signal before the transmission is completed in response to the change, and controlling a decrease slope of the release hydraulic pressure signal before the transmission is completed in response to the change. A transmission system for performing a method of controlling a transmission is also provided.

### CROSS-REFERENCE TO RELATED APPLICATION

The present application claims priority of Korean Patent Application Number 10-2012-0104685 filed Sep. 20, 2012, the entire contents of which application are incorporated herein for all purposes by this reference.

### BACKGROUND OF INVENTION

1. Field of Invention

The present invention relates to a method of controlling a transmission. More particularly, the present invention relates to a method of controlling a transmission for performing control on an engine torque reduction and control on the hydraulic pressure of friction factors in order to improve a feeling of transmission when transmission in an automatic transmission is performed and a transmission system for performing the same.

2. Description of Related Art

An automatic transmission is a system in which a Transmission Control Unit (TCU) controls hydraulic pressure by driving a plurality of solenoid valves depending on driving speed of a vehicle, an open rate of a throttle valve, and all detection conditions and thus a plurality of operating factors is driven so that transmission to a target transmission gear is automatically performed.

In the automatic transmission, a hydraulic pressure system including the solenoid valves functions to selectively drive the operating factors of a power train, that is, a multi-gear transmission mechanism connected to a torque converter. Hydraulic pressure supplied from a hydraulic pump selectively drives some operating factors of a transmission mechanism according to duty control of the solenoid valves, thereby performing transmission.

Here, line pressure and control pressure are formed in order to supply the hydraulic pressure to the plurality of operating factors. The line pressure means a pressure, formed by transmission oil stored in an oil pan and pressurized by the operation of the oil pump, thus forming the control pressure, and then supplied to the solenoid valves. The line pressure is variably controlled by a Variable Force Solenoid Valve (VFS).

If transmission to a target transmission gear is performed, the automatic transmission operation according to this operation principle includes a friction factor (i.e., a release factor) in which an operation state is released and a friction factor (i.e., an engagement factor) in which an operation release state is changed into an operation state. Since the shift performance of an automatic transmission is determined by the operation release timing and operation start timing of the friction factors, active research is recently being carried out on a transmission control method for better shift performance.

In particular, recently, a torque shift problem inevitably occurring in the automatic transmission structure and a transmission performance failure problem due to the high power and high-speed rotation of an engine cannot be solved by independent control on only the automatic transmission. Accordingly, control is performed in association with engine control when transmission is performed, and researches continue to be carried out on this control.

As a basic control form, a transmission shock occurring due to a change of a power state during transmission is reduced by performing hydraulic pressure control on operations (i.e., clutch release and engagement) for the release factor and the engagement factor within a transmission when transmission is performed is performed and also performing engine torque reduction control (i.e., the total control) in some sections when the shift is performed.

Meanwhile, if a driver performs transmission at the same vehicle speed and torque when slow acceleration and sudden acceleration are not taken into consideration, the driver can have a transmission shock when performing slow acceleration and can have a feeling of transmission delay when performing sudden acceleration.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present disclosure has been made in an effort to provide a method of controlling a method of controlling a transmission and a transmission system for performing the same, having advantages of reducing a transmission shock when performing slow acceleration and reducing a feeling of transmission delay when performing sudden acceleration by performing transmission by taking into consideration of a feeling of a driver for a case where the slow acceleration is performed and a case where the sudden acceleration is performed.

Various aspects of the present disclosure provide a method of controlling a transmission. The method includes sensing an operation signal generated from an accelerator pedal sensor, performing a predetermined transmission in a predetermined transmission section from a current gear to a target gear, determining a change in the speed of the operation signal, controlling a constant value at which a release hydraulic pressure signal is maintained constant during the transmission in response to the change in the speed of the operation signal, controlling an increase slope of an engagement hydraulic pressure signal before the transmission is completed in response to the change in the speed of the operation signal, and controlling a decrease slope of the release hydraulic pressure signal before the transmission is completed in response to the change in the speed of the operation signal.

The constant value may be decreased when the change in the speed exceeds a reference value and the constant value may be increased when the change in the speed is equal to or lower than the reference value.

The increase slope of the engagement hydraulic pressure signal may be steep when the change in the speed of the operation signal exceeds a reference value, and the increase slope of the engagement hydraulic pressure signal may be gentle when the change in the speed is equal to or lower than the reference value.

The length of the transmission section may be reduced when the change in the speed exceeds a reference value, and the length of the transmission section may be increased when the change in the speed is equal to or lower than the reference value.

The decrease slope of the release hydraulic pressure signal may be steep when the change in the speed of the operation signal exceeds a reference value, and the decrease slope of the release hydraulic pressure signal may be gentle when the change in the speed of the operation signal is equal to or lower than the reference value.

The reference value of the change in the speed of the operation signal may be 250%/s.

In performing the predetermined transmission, the predetermined transmission may be a kickdown transmission.

Before the transmission is completed, synchronization may be completed at a point of time when a turbine rotation speed reaches a target speed, the engagement hydraulic pressure signal starts increasing and the release hydraulic pressure signal starts decreasing.

The method may further include variably decreasing an output torque of an engine in the transmission section in response to the change in the speed of the operation signal.

A decrease value of the output torque may be reduced when the change in the speed of the operation signal exceeds a reference value, and the decrease value of the output torque may be increased when the change in the speed of the operation signal is equal to or lower than the reference value.

The method may further include controlling the length of the transmission section in response to the change in the speed of the operation signal.

The length of the transmission section may be reduced when the change in the speed of the operation signal exceeds a reference value, and the length of the transmission section may be increased when the change in the speed of the operation signal is equal to or lower than the reference value.

Other aspects of the present disclosure provide a transmission system, including an engine configured to generate a torque, a transmission configured to increase or decrease the torque outputted from the engine and to output the increased or decreased torque, and a control unit configured to control a ratio of an input speed inputted to the transmission and an output speed outputted from the transmission, wherein the control unit performs methods of controlling a transmission.

As described above, in the methods of controlling a transmission in accordance with the present disclosure, when performing slow acceleration at the time of kickdown transmission, a transmission section is increased by controlling the release hydraulic pressure signal and the engagement hydraulic pressure signal so that a driver may have a feeling of a smooth shift. When performing sudden acceleration at the time of kickdown transmission, a transmission section is reduced by controlling the release hydraulic pressure signal and the engagement hydraulic pressure signal so that a driver may have a feeling of a rapid shift.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary transmission system in accordance with the present disclosure.

FIG. 2 is a graph showing signals that are controlled when an exemplary transmission system in accordance with the present disclosure performs slow acceleration kickdown transmission.

FIG. 3 is a graph showing signals that are controlled when an exemplary transmission system in accordance with the present disclosure performs sudden acceleration kickdown transmission.

FIG. 4 is a flowchart illustrating an exemplary method of performing transmission in accordance with the present disclosure.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

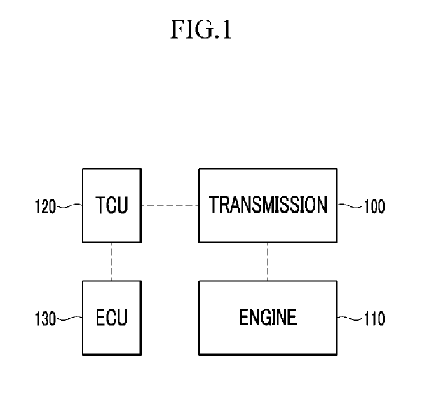

Referring to FIG. 1, the transmission system includes a transmission 100, an engine 110, a Transmission Control Unit (TCU) 120, and an Engine Control Unit (ECU) 130. The TCU 120 and the ECU 130 can be commonly designated as one control unit.

The transmission 100 includes an input shaft for receiving torque outputted from the engine 110 and an output shaft for increasing or decreasing the received torque and outputting the resulting torque. Here, transmission refers to varying a ratio of rotation speed of the input shaft and rotation speed of the output shaft.

When a user presses an accelerator pedal, the ECU 130 senses an operation signal from the accelerator pedal and increases the amount of fuel sprayed to the combustion chamber of the engine 110 and the TCU 120 performs transmission by way of the transmission 100.

For a method and structure in which the transmission 100 performs transmission, reference can be made to known techniques and a detailed description of the method and structure is omitted.

In accordance with various embodiments of the present disclosure, a transmission method is performed by the TCU 120 and the ECU 130. The TCU 120 and the ECU 130 perform a series of programs for executing the transmission method.

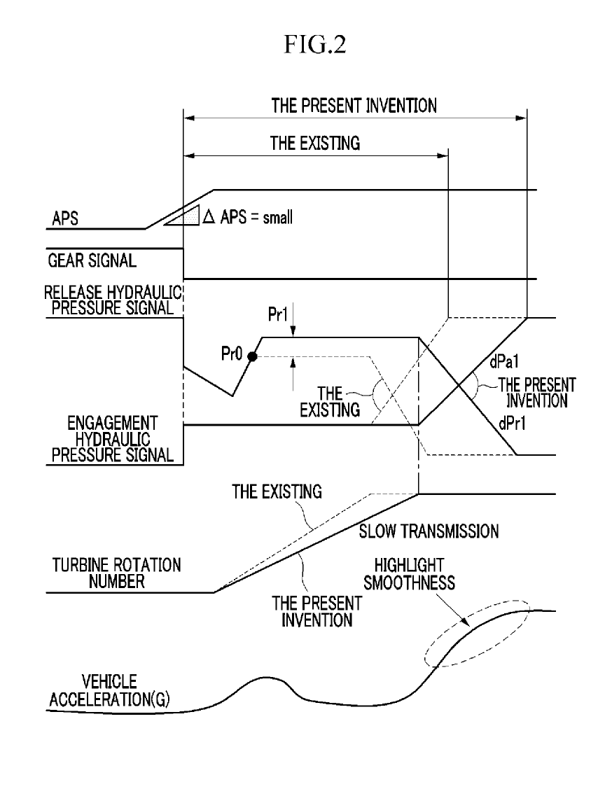

FIG. 2 is a graph showing signals that are controlled when the transmission system in accordance with various embodiments of the present disclosure performs slow acceleration kickdown transmission.

Referring to FIG. 2, when a driver or a user presses the accelerator pedal at constant speed, the operation signal of an Accelerator Pedal Sensor (APS) is increased at a specific slope. Here, the TCU 120 and the ECU 130 sense a change in the speed of the operation signal.

In response to the operation signal, a gear signal for transmission is changed and the release hydraulic pressure signal of a release factor and the engagement hydraulic pressure signal of an engagement factor for transmission are changed.

A change of the release hydraulic pressure signal is described below. The release hydraulic pressure signal suddenly decreases at a point of time at which the gear signal decreases, slowly decreases, slowly increases, and then maintains a constant value in a specific section.

After the constant value remains intact, the release hydraulic pressure signal slowly decreases. Here, the decrease slope is dPr1 and is relatively gentler than the existing slope.

A change of the engagement hydraulic pressure signal is described below. At a point of time at which the gear signal decreases, the engagement hydraulic pressure signal suddenly increases and then maintains a constant value in a specific section.

After the constant value is maintained, the engagement hydraulic pressure signal slowly increases. Here, the rising slope is dPa1 and is relative gentler than the existing slope.

A transmission section at the time of kickdown transmission according to the present disclosure is longer than a transmission section at the time of the existing kickdown transmission. This is because the time that each of the release hydraulic pressure signal and the engagement hydraulic pressure signal is maintained is extended and longer than that of the existing signal and a slope in which each of the release hydraulic pressure signal and the engagement hydraulic pressure signal increases or decreases becomes gentle.

The number of revolutions of the turbine is described below. The number of revolutions of the turbine is slowly increased after the gear signal decreases. The increase slope is slower. A target value of a turbine rotation speed is the same.

Furthermore, regarding vehicle acceleration G, at a point of time at which the transmission is completed, an acceleration value is slowly increased, thereby highlighting smoothness.

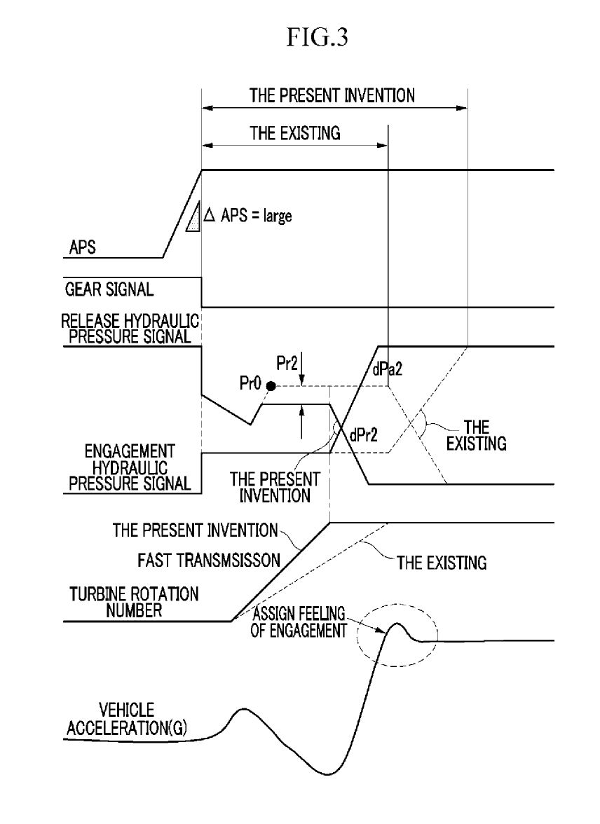

FIG. 3 is a graph showing signals that are controlled when the transmission system in accordance with various embodiments of the present disclosure performs sudden acceleration kickdown transmission.

Referring to FIG. 3, when a driver or a user presses the accelerator pedal at constant speed, the operation signal of the APS is increased at a constant slope. Here, the TCU 120 and the ECU 130 sense a change in the speed of the operation signal.

In response to the operation signal, the gear signal for transmission is changed and the release hydraulic pressure signal of the release factor and the engagement hydraulic pressure signal of the engine factor for transmission are changed.

A change of the release hydraulic pressure signal is described below. The release hydraulic pressure signal suddenly decreases at a point of time at which the gear signal decreases, slowly decreases, slowly increases, and then maintains a constant value in a specific section.

After the constant value is maintained, the release hydraulic pressure signal suddenly decreases. Here, the decrease slope is dPr2 and is relatively steeper than the existing slope.

A change of the engagement hydraulic pressure signal is described below. The engagement hydraulic pressure signal suddenly increases at the point of time at which the gear signal decreases and then maintains a constant value in a specific section.

After the constant value is maintained, the engagement hydraulic pressure signal slowly increases. Here, the increase slope is dPa2 and is relatively steeper than the existing slope.

A transmission section at the time of kickdown transmission according to the present disclosure is shorter than a transmission section at the time of the existing kickdown transmission. This is because the time that each of the release hydraulic pressure signal and the engagement hydraulic pressure signal is maintained is reduced and shorter than that of the existing signal and a slope in which each of the release hydraulic pressure signal and the engagement hydraulic pressure signal increases or decreases becomes steep.

The number of revolutions of the turbine is described below. The number of revolutions of the turbine is slowly increased after the gear signal decreases. The increase slope is more sudden or steeper. A target value of a turbine rotation speed is the same.

Furthermore, regarding vehicle acceleration G, at a point of time at which the transmission is completed, an acceleration value is suddenly increased and then decreased, thereby highlighting a feeling of engagement and rapid transmission.

Referring to FIGS. 2 and 3, when the turbine rotation speed reaches the target value, the engagement hydraulic pressure signal starts increasing and the release hydraulic pressure signal starts decreasing. Here, when the turbine rotation speed reaches the target value, it means that synchronization has been fully completed.

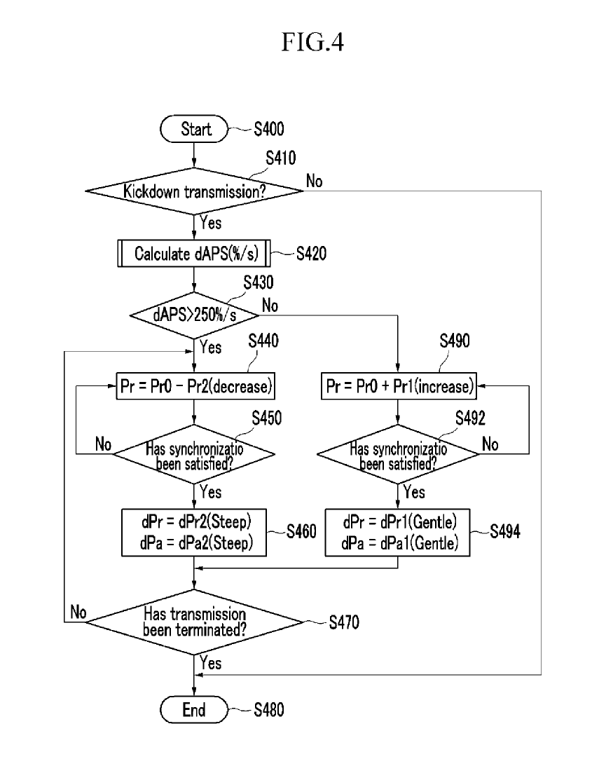

FIG. 4 is a flowchart illustrating an exemplary method for performing transmission in accordance with the present disclosure.

Referring to FIG. 4, control is started at step S400, and whether transmission is kickdown transmission or not is determined based on dAPS %/s, that is, a change in the speed of an operation signal transmitted by the Accelerator Pedal Sensor (APS) at step S410.

If, as a result of the determination, transmission is determined not to be kickdown transmission, the process is terminated. If, as a result of the determination, transmission is determined to be kickdown transmission, a step S420 is performed.

At the step S420, dAPS %/s, a change in the speed of the operation signal, is determined. Then, whether dAPS %/s exceeds 250%/s or not is determined at step S430.

If, as a result of the determination, dAPS %/s is determined to exceed 250%/s, a step S440 is performed. If, as a result of the determination, dAPS %/s is determined to be 250%/s or less, a step S490 is performed.

At the step S440, a constant value at which the release hydraulic pressure signal remains constant in a transmission section is decreased. That is, Pr=Pr0−Pr2

Next, at step S450, whether synchronization is satisfied or not is determined. Here, when synchronization is satisfied, it means that the turbine rotation speed has reached a target speed.

If, as a result of the determination at the S450, synchronization is determined to be satisfied, the release hydraulic pressure signal is decreased at step S460. At this time, the slope becomes steep. That is, the slope becomes steep as much as the constant value is decreased. Here, slopedPr=dPr2.

Furthermore, if, as a result of the determination at the S450, synchronization is determined to be satisfied, the engagement hydraulic pressure signal is increased at step S460. At this time, the slope becomes steep. Here, slopedPa=dPa2.

At a step S490, a constant value at which the release hydraulic pressure signal remains constant in the transmission section is increased. That is, Pr=Pr0+Pr1

Next, at step S492, whether synchronization is satisfied or not is determined. Here, when synchronization is satisfied, it means that the turbine rotation speed has reached target speed.

If, as a result of the determination at the S492, synchronization is determined to be satisfied, the release hydraulic pressure signal is decreased at step S494. At this time, the slope becomes gentle. That is, the slope becomes gentle as much as the constant value has been increased. Here, slopedPr=dPr1.

Furthermore, if, as a result of the determination at the S492, synchronization is determined to be satisfied, the engagement hydraulic pressure signal is increased at step S494. At this time, the slope becomes gentle. Here, slopedPa=dPa1.

In various embodiments of the present disclosure, if synchronization is not satisfied at the steps S450 and S495, the steps S440 and S490 may be repeated.

When the steps S460 and S494 are performed and the step S470 is performed, the transmission is determined to be completed. At step S470, slow acceleration kickdown transmission control and sudden acceleration kickdown transmission control are completed.

In various embodiments of the present disclosure, a step of variably decreasing the output torque of the engine in a transmission section in response to a change in the speed of the operation signal generated from the accelerator pedal can be further included. If the change exceeds a reference value, the decrease value of the output torque can be reduced. If the change is equal to or lower than the reference value, the decrease value of the output torque can be increased.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling a transmission, comprising:
sensing an operation signal generated from an accelerator pedal sensor;
performing a predetermined transmission in a predetermined transmission section from a current gear to a target gear;
determining a change in a speed of the operation signal;
controlling a constant value at which a release hydraulic pressure signal is maintained constant during the transmission in response to the change in the speed of the operation signal;
controlling an increase slope of an engagement hydraulic pressure signal before the transmission is completed in response to the change in the speed of the operation signal; and
controlling a decrease slope of the release hydraulic pressure signal before the transmission is completed in response to the change in the speed of the operation signal.

2. The method of claim 1, wherein the constant value is decreased when the change in the speed of the operation signal exceeds a reference value and the constant value is increased when the change in the speed of the operation signal is equal to or lower than the reference value.

3. The method of claim 1, wherein the increase slope of the engagement hydraulic pressure signal is steep when the change in the speed of the operation signal exceeds a reference value, and the increase slope of the engagement hydraulic pressure signal is gentle when the change in the speed of the operation signal is equal to or lower than the reference value.

4. The method of claim 1, wherein the decrease slope of the release hydraulic pressure signal is steep when the change in the speed of the operation signal exceeds a reference value, and the decrease slope of the release hydraulic pressure signal is gentle when the change in the speed of the operation signal is equal to or lower than the reference value.

5. The method of claim 2, wherein the reference value of the change in the speed of the operation signal is 250%/s.

6. The method of claim 1, wherein the predetermined transmission is a kickdown transmission.

7. The method of claim 1, wherein before the transmission is completed, synchronization is completed at a point of time when a turbine rotation speed reaches a target speed, the engagement hydraulic pressure signal starts increasing and the release hydraulic pressure signal starts decreasing.

8. The method of claim 1, further comprising variably decreasing an output torque of an engine in the transmission section in response to the change in the speed of the operation signal.

9. The method of claim 8, wherein:
a decrease value of the output torque is reduced when the change in the speed of the operation signal exceeds a reference value, and
the decrease value of the output torque is increased when the change in the speed of the operation signal is equal to or lower than the reference value.

10. The method of claim 1, further comprising controlling a length of the transmission section in response to the change in the speed of the operation signal.

11. The method of claim 10, wherein the length of the transmission section is reduced when the change in the speed of the operation signal exceeds a reference value, and the length of the transmission section is increased when the change in the speed of the operation signal is equal to or lower than the reference value.

12. A transmission system, comprising:
an engine configured to generate a torque;
a transmission configured to increase or decrease the torque outputted from the engine and to output the increased or decreased torque; and
a control unit configured to control a ratio of an input speed inputted to the transmission and an output speed outputted from the transmission,
wherein the control unit performs a method according to claim 1.

13. The method of claim 3, wherein the reference value of the change in the speed of the operation signal is 250%/s.

14. The method of claim 4, wherein the reference value of the change in the speed of the operation signal is 250%/s.
